(19) United States
(12) Patent Application Publication
(10) Pub. No.: US 2007/0177698 A1
(43) Pub. Date: Aug. 2, 2007

(54) Signal Transfer Across Circuits Operating in Different Clock Domains

(75) Inventor: Jignesh Shashikant PAWAR, Mumbai (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/307,256

(22) Filed: Jan. 30, 2006

(51) Int. Cl. H04L 7/00

(52) U.S. Cl. 375/354

(57) ABSTRACT

Signal transfer across circuits operating in different clock domains. According to an aspect of the present invention, a freeze signal is generated when it is determined that data is to be transferred from a first clocked element to a second clocked element. The freeze signal thus generated causes the first clocked element to stop updating the corresponding data so that such the data value remains static for some duration. Due to such stopping, signal value (i.e., data) may be reliably transferred to the second clocked element.

### BACKGROUND

FIELD OF THE INVENTION

The present invention relates generally to the design of electronic circuits, and more specifically to a method and apparatus to provide synchronized signal transfers between circuits operating in different clock domains.

### RELATED ART

Circuits often operate in different clock domains. In general, each clock domain is characterized by a corresponding clock signal which is derived from an independent source such that the clock signals can differ in characteristics such as phase and frequency.

For example, one portion of a large integrated circuit may operate from a clock signal derived from one crystal oscillator and another portion of the integrated circuit may operate from a clock signal derived from another crystal oscillator. The portions may operate based on such different clock signals, for example to suit the corresponding operational environment.

Such portions of circuits noted above may contain several sub-portions (building blocks such as flip-flops, registers, shifters etc) which are referred to as clocked elements, each of such clocked element operating with reference to a corresponding clock. For example, a circuit operating in one clock domain in an integrated circuit may contain several clocked elements within it, each of which operates with reference to the same clock. Some examples of such clocked elements are D-type flip-flops, registers and shifters .

There is also a general need to transfer data signals between circuits operating in different clock domains. For example, it may be desirable to transfer a data value or a control signal from one portion to another portion operating in different clock domains.

One problem in such transfers is that signal transfer may not occur reliably if it is not ensured that a receive circuit is provided a desired edge (e.g., rising edge of a clock signal) within an appropriate time duration such that the signal received from another circuit portion is accurately latched. If this not ensured, then a phenomenon generally referred to as meta-stability (a problem well understood in the relevant arts) results.

As such, there is a general requirement of ensuring reliable signal transfers across circuits operating in different clock domains.

### BRIEF DESCRIPTION OF THE DRAWINGS

The present invention will be described with reference to the following accompanying drawings, which are described briefly below.

FIG. (FIG.)1 illustrates an example environment wherein there is a need for ensuring reliable data transfer between two circuits operating in different clock domains.

FIG. 2 is a block diagram illustrating the manner in which reliable signal transfers are sought to be achieved between circuits operating in different clock domains, according to a prior approach.

FIG. 3 is a flow chart illustrating the manner in which data is transferred between two circuits operating in different clock domains according to an aspect of the present invention.

FIG. 4 is a block diagram illustrating several aspects of the present invention in one embodiment.

FIG. 5 is a timing diagram illustrating relevant waveforms of signals involved in data transfers in an embodiment of the present invention.

FIG. 6 is a block diagram illustrating several aspects of the present invention in an alternative embodiment.

FIG. 7 is a block diagram of an example device in which various aspects of the present invention may be implemented.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

According to an aspect of the present invention, a freeze signal is generated when it is determined that data is to be transferred from a first clocked element to a second clocked element. The freeze signal thus generated causes the first clocked element to stop updating the corresponding data so that such the data value remains static for some duration. Due to such stopping, signal value (i.e., data) may be reliably transferred to the second clocked element.

In one embodiment containing a digital signal processor and digital filters (implemented in hardware) implemented in an integrated circuit, a synchronizer circuitry generates a freeze signal in response to a read address generated by the digital signal processor. The freeze signal thus generated is applied to a corresponding data storage element (example, a state register containing a final result or an intermediate result of a filter operation) in a corresponding digital filter to freeze (stop updating) its contents. The digital signal processor can then reliably read such contents(data). Such an implementation results in reduced component count and area on silicon.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

2. Example Environment

FIG. 1 is a block diagram illustrating an example environment wherein there is a need for ensuring reliable data transfer between two circuits operating in different clock domains. The block diagram is shown containing circuit-1 (170) containing clocked elements 120 and 130, circuit-2 (180) containing clocked elements 140 and 150, and synchronizers 125 and 135. Each component is described in greater detail below.

Clocked elements 120 and 130 of circuit-1 operate with reference to clock-A (on path 112). Clocked element 120 receives a data on path 121 (e.g., from a digital processing unit, not shown) and forwards such data (data A) to clocked element 140 on path 122. Clocked element 130 receives a data on path 163(data B)from clocked element 150, and forwards such data on path 131.

Similarly, clocked elements 140 and 150 of circuit-2 operate with reference to clock-B (received on path 113). Clocked element 140 receives a data (data A) from clocked element 120 on path 122 and forwards such data on path 141.Clocked element 150 receives a data on path 151 and forwards such data (data B) to clocked element 130 on path 163.

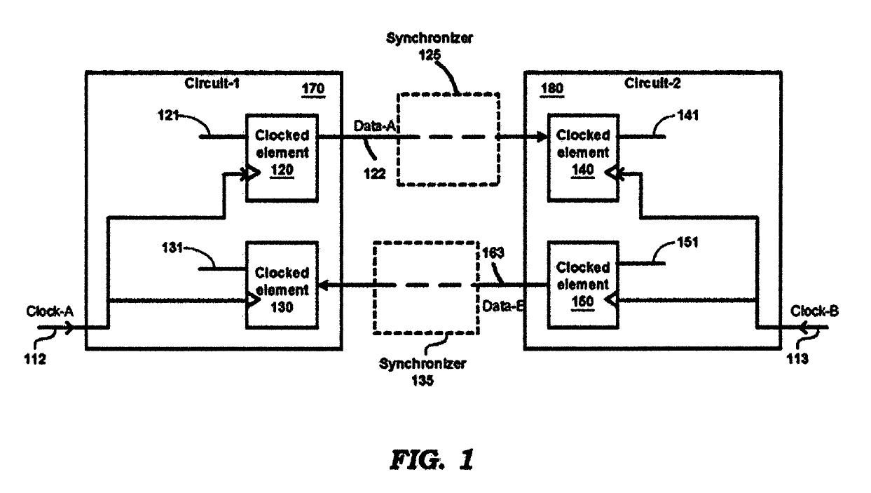

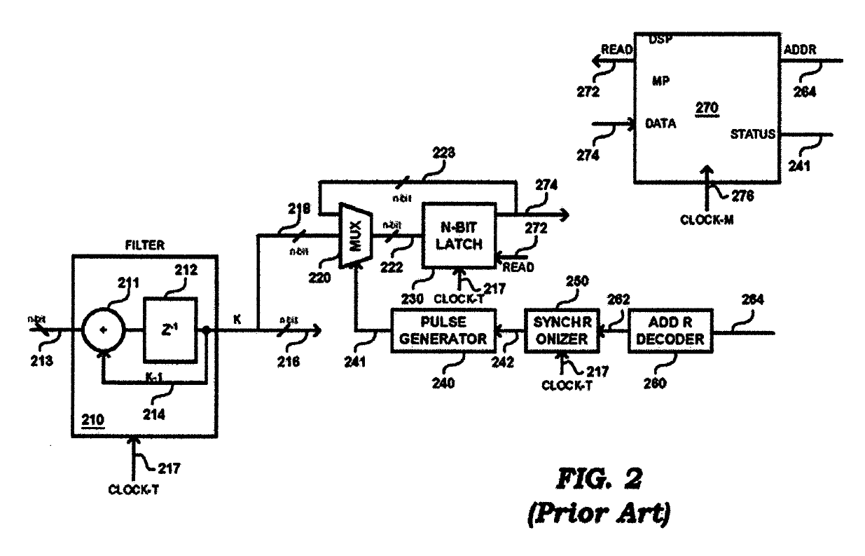

Synchronizers 125 and 135 are circuits that enable transfer of signals in a reliable manner. Various aspects of the present invention facilitate such signal transfers by cooperatively operating with the clocked elements. The corresponding features will be clearer in comparison with a prior approach, and accordingly the details of such a prior approach are described below with respect to FIG. 2.

3. Prior Approach to Signal Transfers

FIG. 2 is a block diagram illustrating the manner in which reliable signal transfers are sought to be achieved between circuits operating in different clock domains, according to a prior approach. The approach uses circuitry to synchronize such transfers with respect to the different clocks as described below.

FIG. 2 is shown containing blocks filter 210, multiplexer (MUX) 220, N-bit latch 230, pulse generator 240, synchronizer 250, address decoder 260 and microprocessor 270. (MUX) 220, N-bit latch 230, pulse generator 240, synchronizer 250 and address decoder 260 operate to provide synchronized data transfer from filter 210 to microprocessor 270. Each block is described in detail below.

Filter 210 is shown as an IIR filter containing delay element 212 and summer 211. Filter 210 receives an n-bit data (for example 16-bit data representing the voltage level of a sample of an analog signal) on path 213 and operates to filter such data in a manner specified by multiplication factors k and (k−1) on paths 215 and 214 respectively. Filter block 210 operates with reference to clock-T 217.

Filter 210 may contain several data registers internally, each of which may hold state information regarding the filter operation. Such state information may be in the form of intermediate computational results of a filter operation. The output of filter 210 is available on path 216, where such output may be used by subsequent circuit elements(not shown). The output of filter 210 (n-bit) is also available on path 218.

Microprocessor 270 operates with reference to clock-M on path 276, and may be implemented as a general purpose microprocessor or a digital signal processor. Microprocessor 270 performs various control and processing functions based on instructions provided to it (either internally stored or provided from a memory device, not shown). Microprocessor 270 is shown with address bus (path 264), data bus (path 274), a read signal (path 272) and a status terminal (received from path 241). Other signals and terminals of the microprocessor are not shown in the interest of conciseness.

MUX 220, n-bit latch 230, pulse generator 240, synchronizer 250 and address decoder 260 operate to synchronize data transfers from filter 210 to microprocessor 270 as is explained below.

Address decoder 260 operates to decode addresses generated on path 264 and further generate appropriate control signals for accessing devices connected to microprocessor 270 (only filter 210 is shown). Address decoder 260 generates a control signal on path 262 when received address on path 264 indicates that filter 210 (or a data register within filter 210) is to be accessed.

Synchronizer 250 operates to synchronize the control signal received on path 262 with clock-T 217. Synchronizer 250 is typically implemented as a cascade of 2 flip-flops, each of which is clocked by clock-T (as is well known in the relevant arts). The output of synchronizer 250 (on path 242) represents a signal which is synchronous with clock-T and is provided as an input to pulse generator 240.

Pulse generator 240 generates a pulse (on path 241) in response to an active edge of the input received on path 242. The width of this pulse is typically of the duration of the signal received on path 242.

MUX 220 represents a multiplexer which forwards on path 222 data received either on path 218 or path 223 based on the value of the pulse received on path 241. For example, MUX 220, may forward data on path 218 if pulse on path 241 has a value logic 0, and forward data on path 223 if pulse on path 241 has a value logic 1. MUX 220 is shown as being implemented to operate on n-bit data as indicated by the width of inputs on path 218 and 223 and output 222.

N-bit latch 230 latches (stores) an input received on path 222 in response to an active edge of clock-T 217. The latched input is available on path 274 where it may be read by microprocessor 270. The output of n-bit latch 230 is also available as an input to MUX 220 on path 223. N-bit latch 230 operates on n-bit data and the input and output paths are each n bits wide.

The mechanism by which data transfer from filter 210 to microprocessor 270 is synchronized is now explained below.

It may be seen that filter 210 and microprocessor 270 operate in different clock domains, filter 210 operating with reference to clock-T and microprocessor 270 operating with reference to clock-M. When microprocessor 270 needs to access data ( for example the output of filter 210) from filter 210, it generates a corresponding address indicating that a corresponding data register in filter 210 is to be accessed.

Address decoder 260 decodes such an address and generates a control signal (262) which is synchronized to the clock of filter 210 (clock-T) by synchronizer block 250 and forwarded to pulse generator 240. Pulse generator 240 generates a pulse used to latch the output of filter 210 in n-bit latch 230(as described earlier), thereby causing MUX 220 to forward the data on path 218 to path 222.

The active edge of the output of pulse generator 240 is used as a status signal to microprocessor 270 (on its status terminal), indicating that data from filter 210 can be reliably read. In response to such a status signal, microprocessor reads the output (equivalent to the n-bit output of a data register of filter 210 that was to be transferred) of n-bit latch, by activating a read signal (path 272). Microprocessor 270 may then operate on the read data in a desired manner.

An environment such as the one described above may contain several such outputs that may need to be read. Typically a 1-bit latch (of the type such as N-bit latch 230) requires 10 NAND gates. Therefore it may be appreciated that for a large number of such data, each of which may be several bits wide (example 16/32), a large number of equivalent latches will be required. Consequently, the number of components as well as area occupied by those components increases. At least in certain environments, such as integrated circuits, component count and area taken up are chief constraints during design and fabrication.

Therefore what is required is a method and apparatus which can overcome some of the drawbacks of the approach described above. The present invention describes such a method and apparatus.

4. Invention

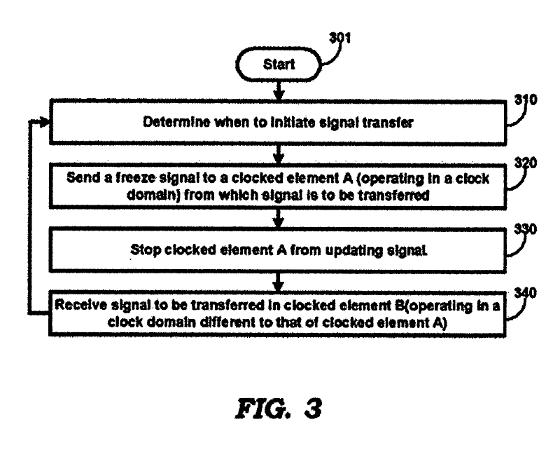

FIG. 3 is a flow chart illustrating the steps involved in transferring data between two circuits operating in different clock domains according to an aspect of the present invention. The flow chart starts at step 301, where control passes to step 310.

In step 310, a determination is made as to when a signal is to be transferred from a clocked element A operating in a clock domain. Such a determination can be made based on considerations specific to the environment in which the approaches are being implemented. Control then passes to step 320.

In step 320, a freeze signal is generated in response to the determination made in step 310. The freeze signal may identify the characteristics (e.g., start time, length of duration, etc.) of a duration in which the signal (to be transferred) value needs to be stopped from changing as described below. Control then passes to step 330.

In step 330, clocked element A stops updating the signal to be transferred, in response to the freeze signal. Stopping the updations can be performed using one of several techniques well known in the relevant arts, as will be apparent to one skilled in the relevant arts by reading the disclosure herein. Control then passes to step 340.

In step 340, the signal of interest is retrieved from clocked element A. As the signal of interest is static (not updated), the value of the signal can be reliably retrieved. The read value can then be transferred to clocked element B, potentially using the clock signal corresponding to the second clock domain. Control then goes back to step 310.

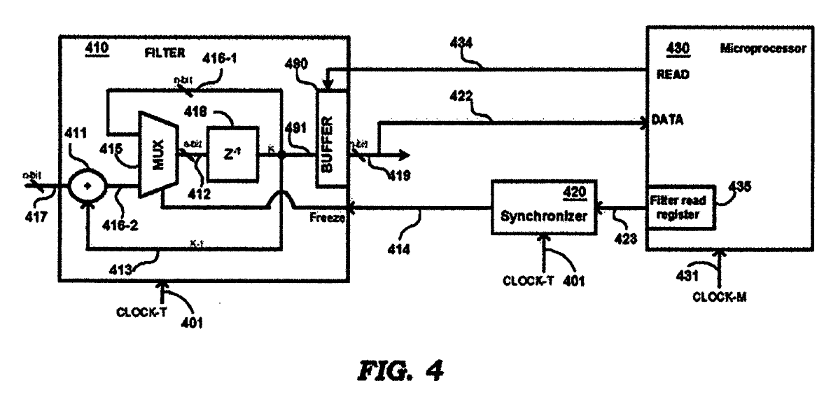

The approaches of FIG. 3 can be implemented in various environments. An example embodiment in which the approach is implemented is now described with reference to FIG. 4.

5. Circuit Diagram

FIG. 4 is a block diagram illustrating several aspects of the present invention in one embodiment. The block diagram is shown containing blocks filter 410, microprocessor 430 and synchronizer 420. Each component is described in detail below.

Filter 410 is shown as a first order IIR filter containing delay element 418, summer 411, multiplexer (MUX) 415 and buffer 490. Filter 410 receives an n-bit data (for example 16-bit data representing an analog signal) on path 417, and operates to filter such data in a manner specified by multiplication factors k and (k−1)on paths 419 and 413 respectively.

MUX 415 forwards on path 412 one of either data on path 416-2 or data on path 416-1, depending on the binary value of the control signal on path 414. For example, MUX 415 may forward data on path 416-2 on path 412 if the value of the control signal on path 414 is a logic 0, and may forward data on path 416-1 on path 412 if the value of the control signal on path 414 is a logic 1. Effectively, data on path 416-2 represents a next value of data at the output (path 419/422).

Thus, when control signal 414 is at logic 1, output 491 of filter 410 does not change (remains static). Accordingly, MUX 415 along with the associated control signal 414 (receiving the freeze signal) is referred to as a freeze circuit. It should be appreciated that various alternative approaches can be used to implement freeze circuits, as will be apparent to one skilled in the relevant arts by reading the disclosure herein.

Filter 410 operates with reference to clock-T 401. The output of filter 410 is available on path 491, where it is provided as an input to buffer 490. Buffer 490 can be implemented as a tri-state buffer to provide sufficient drive to input on path 491. The output of buffer 490 on paths 419/422, may be activated by an enable signal on path 434. Output on path 419 may be used by subsequent circuit elements (not shown).

Although it has been mentioned above that buffer 490 of FIG. 4 is implemented as a tri-state buffer, in certain environments, buffer 490 can be implemented without tr-state control. Such an implementation may be used, for example, in an environment containing a digital signal processor (corresponding to microprocessor 430) connected to filter 410 through an OCP (open-core protocol) bus.

The output of filter 410 (n-bit) is also available on path 416-1. All data paths in filter 410 are n-bits wide in one embodiment.

Filter 410 may contain several data registers internally, each of which may hold relevant data. The output of filter 410 is available on path 419, where such output may be used by subsequent circuit elements (not shown). The output of filter 410 (n-bit) is also available on path 422.

Data contained in any internal register may be accessed through path 422 (explained below). Further, filter 410 may be implemented as a higher order filter, in which case there will be a corresponding number of multiplexers, delay elements and summers, similar to MUX 415, delay element 418 and summer 411 respectively. Such a higher order filter may contain several data registers each containing data corresponding to state (filter operation) information, in the form of intermediate computational results of a filter operation.

Therefore, although in FIG. 4 path 422 is shown as being connected to the output, it must be understood that data contained in some or all the internal registers can also be accessed through path 422, using appropriate mechanisms well known in the relevant arts.

Microprocessor 430 operates with reference to clock-M on path 431, and may be implemented as a general purpose microprocessor or a digital signal processor. Microprocessor 430 performs various control and processing functions based on instructions provided to it ( either internally stored or provided from a memory device, not shown), and is shown containing data bus (path 422), a read terminal (connected to path 434) and filter read register (435). Other signals and terminals of the microprocessor not relevant for this description are not described/shown in the interest of conciseness.

Filter read register 435 is an internal register of microprocessor 430, and may contain several control bits, each signifying whether a data register inside filter 410 be accessed (read) or not. For example, filter read register 435 may be 16 bits wide, with each bit acting as a control bit specifying a read operation on one of 16 data registers in filter 410. A logic 1 may signify a read operation, while a logic 0 does no function. The opposite scheme may also be used, wherein a logic 0 signifies a read operation.

Control bits in filter read register 435 are set (signifying a read request) or reset (no operation/end operation) depending on a program (running on microprocessor 430) generating a corresponding address signifying a data register inside filter 410. For example, if the program needs to access the output data register (containing a final filtered value of n-bit data received on path 417), it may generate a suitable address, which in turn will set a corresponding control bit in filter read register 435. Appropriate portions of the circuit of FIG. 4 may be modified suitably to enable reading of any register that may be contained in filter 410. The output (control signal) of filter read register 435 is available on path 423.

Synchronizer 420 operates to synchronize the control signal received on path 423 with clock-T 401, and may be implemented as a cascade of two flip-flops, each of which is clocked by clock-T (as would be apparent to one skilled in the relevant arts). The output of synchronizer 420 (on path 414) represents a signal (freeze signal) which is synchronous with clock-T and is provided as a control input to MUX 415.

The manner in which data is transferred from filter 410 to microprocessor 430 is now explained below.

It may be seen that filter 410 and microprocessor 430 operate in different clock domains, filter 410 operating with reference to clock-T and microprocessor 430 operating with reference to clock-M. When microprocessor 430 needs to access data ( for example the output of filter 410) from filter 410, it generates a corresponding address indicating that a corresponding data register in filter 410 is to be accessed. Such an address generated is used to cause a corresponding control bit in filter read register 435 to be set.

The output of filter read register 435 (which corresponds to a control bit that has been set) is synchronized to the clock of filter 410 (clock-T) by synchronizer 420 and forwarded to a control input of MUX 415 on path 414. The control input on path 414 represents a freeze signal and is used to control which of the inputs (416-1 and 416-2) to MUX 415 is made available on path 412 and hence on path 422, where it may be read by microprocessor 430. The read operation is completed when microprocessor 430 ends the read cycle (thereby causing the corresponding control bit in filter read register 435 to be reset to logic zero), after having read data on path 422. It is noted here that if clock-T has a much lower frequency compared with clock-M, then microprocessor 430 may have to introduce additional wait states to complete the read operation described above.

In an environment containing a (DSP) digital signal processor (corresponding to microprocessor 430 of FIG. 4) connected to a filter (corresponding to filter 410 of FIG. 4) through an OCP (open-core protocol) bus, data transfer operation from the filter to the digital signal processor can be summarized as given below. (For conciseness of description, it has been assumed that the digital signal processor and filter connected by the OCP bus have similar named components as in FIG. 4, and the details of the OCP bus signals and protocol have been omitted so as not to obscure the details of the invention).

a. DSP writes to register 435 and sets a freeze bit. b. DSP reads register 418, which is mapped to the DSP's address space. (DSP may insert wait-states if clock-T has a much lower frequency when compared with clock-M). c. DSP clears the freeze bit in register 435.

MUX 415 may be implemented such that a logic 1 (on path 414) causes input on path 416-1 to be forwarded on path 412, and a logic 0 (on path 414) causes input on path 416-2 to be forwarded on path 412.

It may be seen that when input on path 414 causes MUX 415 to forward input (data) on path 416-1 to path 412 (and consequently on path 422 and 419), such data is effectively frozen (prevented from changing) due to the feedback from path 422/419 to input of MUX on path 416-1. Therefore, it is ensured that data to be read (and available on path 422/419) is prevented from changing, and microprocessor 430 can read such data reliably by activating a read signal on path 434 and receiving such data on path 422.

The technique described above is further illustrated with respect to appropriate waveforms (timing diagram).

6. Timing diagram

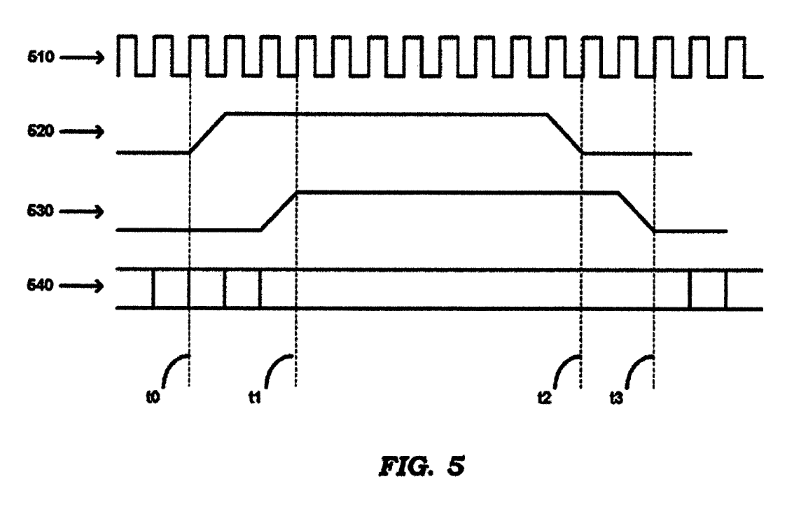

FIG. 5 is a timing diagram illustrating relevant waveforms of signals involved in data transfers between filter 410 and microprocessor 430. Signal 510 represents clock-T (401 of FIG. 4) which is the clock input to filter 410. Signal 520 represents a read signal (path 434 of FIG. 4) from microprocessor 430 to filter 410. Signal 530 represents a freeze signal (path 414 of FIG. 4). Signal 540 represents data to be read from filter 410. The signals are described in further detail below.

As may be seen from FIG. 5, read signal 520 is active between time points t0 and t2. Such a read signal signifies that data from filter 410 is to be read. Corresponding to the read signal going active at t0, appropriate address of data register in 410 which is to be read is generated inside microprocessor 430 and a corresponding control bit is set in filter read register 435 (of FIG. 4) as described earlier.

Freeze signal 530 is shown asserted some time after t0, and thus is shown to be active between time points t1 and t3, effectively preventing the appropriate data register in filter 410 from changing its data contents. Time interval t1-t3 represents the duration for which data is static and may be reliably read from filter 410. The read data/signal may be immediately received by microprocessor 430.

Microprocessor latches (internally) data (waveform 540) at a time instant t2 (in the duration t1-t3). As may be appreciated from FIG. 5, such latching occurs within a time interval wherein data 540 is static (not changing). This ensures reliable data transfer from filter 410 to microprocessor 430.

The approach described in section 5 may be applied to other environments also. One such environment wherein IIR filter 410 is replaced by an FIR filter, is described in the next section.

7. Alternative Embodiment

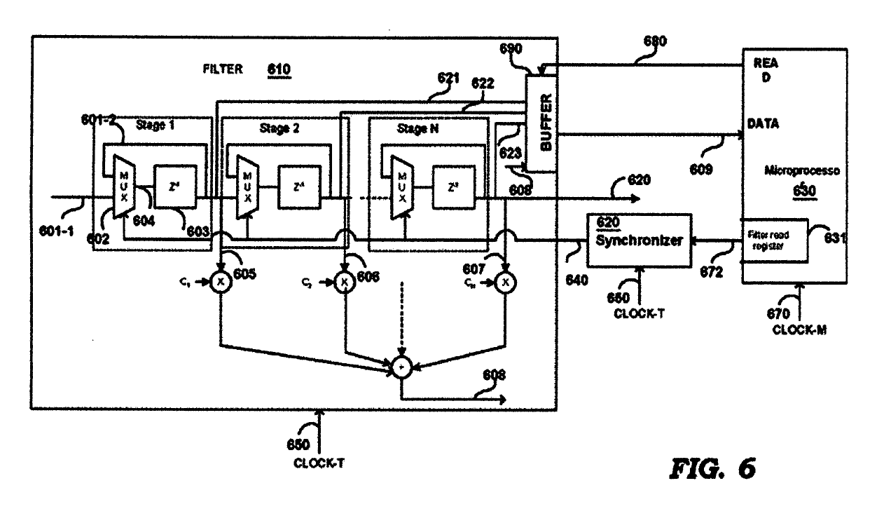

FIG. 6 is a block diagram illustrating the details of an alternative embodiment. The block diagram is shown containing FIR filter 610, micro-processor 630 and synchronizer 620. Each block is further described below.

FIR filter 610 operates with reference to clock-T (on path 650), and is shown containing stages 1 through N. Stage 1 contains delay element 603, multiplexer (MUX) 602 and buffer 690. Stage 1 receives an n-bit (example 16/32 bits) input data that is to be filtered on path 601-1. MUX 602 forwards one of inputs on path 601-1 and 601-2 to delay element 603, on path 604. The output of stage 1 is available on path 605, where it is used as an input to stage 2 and to a multiplier with gain C1.

Subsequent stages 2 through N may operate in a similar fashion, and their description is not provided here in the interest of conciseness.

Outputs of stages 1 through N are available on paths 621 through 623, where they are input to buffer 690. Output of filter operation is available on path 608 and is also input to buffer 690. Buffer 690 may be implemented as a tri-state buffer and provides sufficient drive to input on paths 621 through 623 and 608. Output of buffer 690 (path 609) may be enabled by an output enable signal to buffer 690 on path 680.

Output of buffer 690 may be read by microprocessor 630. (Only outputs of stages labeled as 1, 2 and N are shown as being connected to microprocessor 630, for conciseness). A read operation on filter 610 may be enabled by sending an active signal on path 680 to the output enable terminal of buffer 690.

Microprocessor 630 operates with reference to clock-M on path 670, and may be implemented as a general purpose microprocessor or a digital signal processor. Microprocessor 630 performs various control and processing functions based on instructions provided to it (either internally stored or provided from a memory device, not shown), and is shown containing data bus (some lines of which are shown connected to paths 621, 622, 623 and 608), a read terminal connected to path 680, and filter read register (631). Other signals and terminals of the microprocessor not relevant for this description are not described/shown in the interest of conciseness. Filter read register operates similar to the corresponding description with respect to FIG. 4 and is not repeated here.

Similarly, synchronizer 620 operates similar to synchronizer 420 described above with respect to FIG. 4.

The manner in which signal transfer is achieved reliably across filter 610 and microprocessor 630 is similar to the description provided with respect to FIG. 4, and will only be briefly noted below.

An active output (freeze signal) of synchronizer 620 (generated in response to an appropriate control bit being set in filter read register 631) is used to freeze (stop updation) of the contents (data ) at various stages 1 through N and the final output on path 608. Such a freeze operation is achieved by causing MUX 602 (and corresponding MUXes of other stages) to forward data from the feedback path (represented by path 601-2 in the case of stage 1) to the corresponding delay element, and hence to the respective outputs of each stage. This operation is similar to that described earlier with respect to FIG. 4.

Microprocessor 630 may then read such data (on paths 621, 622, 623 and 608, buffered by buffer 690) and process them as required. It should be appreciated that the relevant data paths may be of any bit width, depending on the specific environment.

Thus, using the freeze signal above, reliable data transfers may be obtained in various environments as described above. The approaches described above can be implemented in various devices, as described below with an example.

8. Device

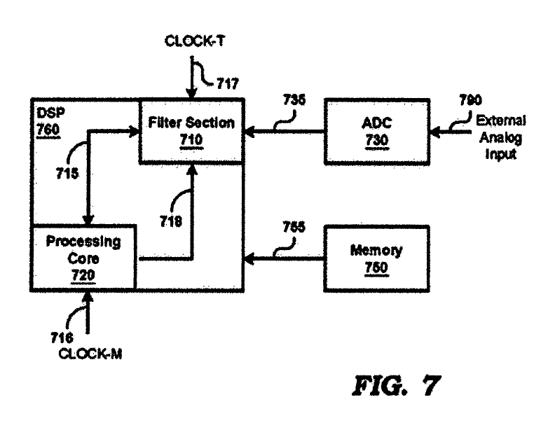

FIG. 7 is a block diagram of an example device in which various aspects of the present invention may be implemented. The example device is shown containing digital signal processor (DSP) 760, analog to digital converter (ADC )730 and memory 750. Each block is described further below.

DSP 760 represents a processing device that may be used for signal processing applications. DSP 760 is shown containing processing core 720 and filter section 710. Processing core 720 performs various processing related activities of DSP 760 and operates with reference to clock-M 716. Filter section 710 operates with respect to clock-T (735), and may implement required hardware functions for filtering data received from ADC 730 on path 735.

ADC 735 receives an external analog input on path 790 and converts such input to a corresponding digital code which is forwarded to filter section 710 on path 735. ADC 735 may be implemented using well known techniques.

Memory 750 may contain instructions (program) for controlling the operation of DSP 760, and such program instructions are forwarded to DSP 760 on path 755.

When processing core 720 needs to read data from filter section 710, it may generate a freeze signal on path 718 (using techniques described in earlier sections). Such a freeze signal causes filter section 710 to stop updating (freeze) the contents of the relevant data register. The required data may then be read by processing core 720 on path 715.

9. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of synchronizing transfer of data signals from a first element to a second element, said first element being clocked by a first clock signal and said second element being clocked by a second clock signal, said first clock signal and said second clock signal respectively operating in a first clock domain and a second clock domain, wherein said first clock domain is not identical to said second clock domain, said method comprising:
determining when to initiate transfer of a data signal present at said first element to said second element;
sending to said first element a freeze signal upon said determining;
freezing said data signal in said first element for at least a finite duration in response to reception of said freeze signals such that said data signal does not change during said finite duration; and
reading said data signal from said first element in said finite duration.

2. The method of claim 1, wherein said finite duration is specified by said freeze signal sent to said first clocked element.

3. The method of claim 2, further comprising receiving said data signal from said first element in conjunction with said reading.

4. The method of claim 3, wherein said second element is contained in a processor which performs said determining, said method further comprising sending a control signal upon said determining to initiate transfer of said data signal.

5. The method of claim 4, further comprising forming said freeze signal from said control signal.

6. A signal transfer circuit transferring data signals from a first element to a second element, said first element being clocked by a first clock signal and said second element being clocked by a second clock signal, said first clock signal and said second clock signal respectively operating in a first clock domain and a second clock domain, wherein said first clock domain is not identical to said second clock domain, said signal transfer circuit comprising:
a synchronizer sending a freeze signal;
a freeze circuit freezing a data signal in said first element for at least a finite duration in response to reception of said freeze signal such that said data signal does not change in said first element during said finite duration; and
a read circuit reading said data signal from said first element in said finite duration.

7. The signal transfer circuit of claim 6, wherein said freeze circuit comprises a multiplexer selectively providing on an output path either a next value of said data signal or a present value of said data signal stored by said first element according to a freeze signal, wherein said output path is coupled to store the selected value in said first element.

8. The signal transfer circuit of claim 6, wherein said read circuit reads said data signal according to an edge of said second clock signal.

9. The signal transfer circuit of claim 6, wherein said second element and said read circuit are comprised in a processor.

10. The signal transfer circuit of claim 7, further comprising an output buffer coupled to said output path of said multiplexer, wherein said read circuit comprised in said processor sends a read signal to said output buffer to read said data signal from said output buffer.

11. The signal transfer circuit of claim 6, wherein said synchronizer generates said freeze signal based on a control signal received from said second element.

12. The signal transfer circuit of claim 11, wherein said synchronizer comprises a cascade of one or more flip-flops, each of said one or more flip-flops operating with reference to said first clock signal.

13. An article of manufacture for synchronizing transfer of data signals from a first element to a second element, said first element being clocked by a first clock signal and said second element being clocked by a second clock signal, said first clock signal and said second clock signal respectively operating in a first clock domain and a second clock domain, wherein said first clock domain is not identical to said second clock domain, said article comprising:
means for determining when to initiate transfer of a data signal present at said first element to said second element;
means for sending to said first element a freeze signal upon said determining;
means for freezing said data signal in said first element for at least a finite duration in response to reception of said freeze signals such that said data signal does not change during said finite duration; and
means for reading said data signal from said first element in said finite duration.

14. The article of claim 13, wherein said finite duration is specified by said freeze signal sent to said first clocked element.

15. The article of claim 14, further comprising means for receiving said data signal from said first element in conjunction with said reading.

16. The article of claim 15, wherein said second element is contained in a processor which performs said determining, said article further comprising means for sending a control signal after said means for determining determines to initiate transfer of said data signal.

17. The article of claim 16, further comprising means for forming said freeze signal from said control signal.
